(19) United States
(12) Patent Application Publication
(10) Pub. No.: US 2008/0274251 A1
(43) Pub. Date: Nov. 6, 2008

(54) Shelf-stable Sweet Goods Dough

(76) Inventor: Linda C. Paulson, Plymouth, MN (US)

Correspondence Address: FISH & RICHARDSON P.C., PO BOX 1022, MINNEAPOLIS, MN, 55440-1022, US

(21) Appl. No.: 12/123,815

(22) Filed: May 20, 2008

Related U.S. Application Data
(63) Continuation-in-part of application No. PCT/US2007/062962, filed on Feb. 28, 2007.
(60) Provisional application No. 60/777,640, filed on Feb. 28, 2006.
(60) Provisional application No. 60/809,252, filed on May 30, 2006.

(51) Int. Cl. A21D 10/02

(52) U.S. Cl. 426/532; 426/549; 426/555

(57) ABSTRACT

A shelf-stable cookie dough exhibiting marked reduction in the deleterious effects of aging at ambient and refrigerated temperatures is presented. The present sweet goods dough is formulated from common bakery ingredients in such a way that discoloration as a result of age is significantly reduced. In addition, the present sweet goods dough exhibits retention of fats and oils such that the dough mixture remains largely homogeneous for periods up to six months. The texture and manageability of the dough remains soft and pliable, and biological growth is all but excluded under ambient climates. The present sweet goods dough exhibits these effects while offering the consumer a delicious treat that may be stored for extended periods under non-refrigerated conditions.

### CLAIM OF PRIORITY

This application is a continuation-in-part of PCT Application Serial No. PCT/US2007/062962, filed Feb. 28, 2007, which claims priority under 35 U.S.C. § 119(e) to U.S. Patent Application Ser. No. 60/777,640, filed on Feb. 28, 2006, and U.S. Patent Application Ser. No. 60/809,252, filed on May 30, 2006, all of which are hereby incorporated by reference in their entirety.

### TECHNICAL FIELD

This invention relates to sweet goods dough, and more particularly to shelf-stable sweet goods dough.

### BACKGROUND

Consumption of sweet goods has been a human indulgence for much of recorded history. In the past, sweet goods doughs, usually consisting of proportions of flour, sweetener, water, and a leavening agent, have been mixed and either immediately baked to produce a sweet goods product such as a cookie, or refrigerated for later use. As with most foodstuffs, combating microbial growth and other spoilage processes in dough products during storage is a plaguing issue. Manufacturers and consumers of sweet goods dough products would surely benefit from reduced effects of spoilage, which include mold growth, separation of constituent components, texture stability, and color changes associated with chemical reactions such as Maillard browning. These processes become increasingly difficult to contend with when the dough is not refrigerated, which naturally slows down organism growth and undesirable chemical and biological reactions.

In the past, controlling growth of unwanted living organisms in stored doughs has been accomplished both with the use of chemical antimicrobial agents and by adjusting certain properties of the dough to produce physiological conditions that inhibit organism growth. Barley flour is an ingredient that some producers add to their sweet goods dough because it contains enzymes and other ingredients that naturally inhibit mold growth. However, this type of flour may contribute an unpleasant texture to the dough and some find the taste imparted by barley flour to be unpleasant. Other routes of controlling microbial growth include regulating the pH of the dough and keeping the water activity of the dough below certain levels. Doughs with lower moisture content usually suffer less microbial growth, however, moisture is an important constituent that lends to the overall desirability of the finished product. Finding the right balance between moisture content that inhibits biological growth while preserving subjective qualities such as taste and texture, may be an arduous task for sweetdough developers.

Sweet goods doughs which do not require storage in a refrigerator, so-called “shelf-stable” doughs, may present the toughest challenge with regard to their storage lifetime. Components of the doughs may begin to separate. For example, blended oils, which are desirable in the baked product because they contribute to mouthfeel, may separate from the dough mixture and pool on top of the dough. Subjective attributes of the dough, such as color or texture, may also change rapidly over time and often times the end product received by a consumer may be drastically different than that produced by the dough producer.

A desirable, shelf-stable sweet goods dough that resists microbial growth and the spoilage processes mentioned above would benefit both producers and consumers by offering a product that may be stored for extended periods of time in non-refrigerated conditions and still remain desirable when the consumer is ready to bake.

### SUMMARY

Provided herein is a shelf-stable, yeastless sweet goods dough composition that includes: from about 8 to about 25% by weight of fats and oils, from about 0.5 to about 4% by weight powdered eggs, from about 5 to about 25% by weight of sucrose, from about 6 to about 60% by weight of a liquid sweetener, from about 12 to about 40% by weight of flour, from about 0 to about 10% by weight of neat water, from about 0 to about 1.0% by weight antimicrobial agent, from about 0.2 to about 1.2% by weight salt, from about 0 to about 5% by weight molasses, and from about 0.5 to about 2.0% by weight leavening agent.

In some embodiments, a shelf-stable, sweet goods dough composition may include: from about 12 to about 23% by weight of fats and oils; from about 1.5 to about 3% by weight powdered eggs; from about 18 to about 23% by weight sucrose; from about 6 to about 20% by weight of a liquid sweetener; from about 10 to about 35% by weight flour; from about 2 to about 8% by weight water; from about 0.4 to about 1% by weight antimicrobial agent; from about 0.4 to about 1.0% by weight salt; from about 0 to about 3% molasses; and from about 0.5 to about 1.5% by weight leavening agent.

In another embodiment, a shelf-stable, yeastless sweet goods dough composition may include: 13.75% by weight of fats and oils; 2% by weight powdered eggs; 20.62% by weight of sucrose; 12% by weight of a liquid sweetener; 27.49% by weight of flour; 4.5% by weight of neat water; 0.59% by weight antimicrobial agent; 0.6% by weight salt; 0.2% by weight molasses; 0.2% by weight vanilla flavoring; 0.25% by weight butter flavoring; 1.32% by weight leavening agent; and 16.49% by weight flavor additives.

In certain embodiments, a shelf-stable, yeastless sweet goods dough composition may include: 14.13% by weight of fats and oils; 2.01% by weight powdered eggs; 20.19% by weight of sucrose; 12.04% by weight of a liquid sweetener; 28.27% by weight of flour; 3.51% by weight of neat water; 0.60% by weight antimicrobial agent; 0.85% by weight salt; 0.2% by weight molasses; 0.17% by weight vanilla flavoring; 0.50% by weight butter/vanilla flavoring; 1.32% by weight leavening agent; and 16.56% by weight flavor additives.

In further embodiments, a shelf-stable, yeastless sweet goods dough composition may include: 16.93% by weight of fats and oils; 1.64% by weight powdered eggs; 19.59% by weight of sucrose; 8.85% by weight of a liquid sweetener; 24.40% by weight of flour; 5.92% by weight of neat water; 0.55% by weight antimicrobial agent; 0.55% by weight salt; 1.50% by weight molasses; 0.73% by weight leavening agent; 7.66% by weight peanut butter; 2.55% by weight peanut flour; and 9.0% by weight flavor additives.

In other embodiments, a shelf-stable, yeastless sweet goods dough composition may include: 14.17% by weight of fats and oils; 2.05% by weight powdered eggs; 18.29% by weight of sucrose; 12.32% by weight of a liquid sweetener; 14.17% by weight of flour; 4.11% by weight of neat water; 0.62% by weight antimicrobial agent; 0.26% by weight salt; 2.56% by weight molasses; 0.1% by weight vanilla flavoring; 0.62% by weight leavening agent; 0.21% by weight cinnamon; 21.25% by weight oats; and 9.25% by weight raisins.

In another embodiment, a shelf-stable, yeastless sweet goods dough composition may include: 20.92% by weight of fats and oils; 2.10% by weight powdered eggs; 20.91% by weight of sucrose; 16.0% by weight of a liquid sweetener; 33.33% by weight of flour; 5.0% by weight of neat water; 0.59% by weight antimicrobial agent; 0.5% by weight salt; 0.063% by weight butter/vanilla flavoring; and 0.59% by weight leavening agent.

In some embodiments, a shelf-stable, yeastless sweet goods dough composition includes: 20.10% by weight of fat and oils; 17.53% by weight of sucrose; 10.48% by weight of a liquid sweetener; 0.70% by weight leavening agent; 0.23% by weight of salt; 3.49% by weight powdered eggs; 5.82% by weight of neat water; 0.24% by weight vanilla flavoring; 4.66% by weight of cocoa; 17.53% by weight flour; and 19.23% by weight of chocolate chips.

In the above embodiments, the total water content of the dough composition can be about 4.5% by weight; the pH of the dough can be about 6.8 to about 7.2, the dough can have a water activity in the range of about 0.65 to about 0.75, in some cases 0.72, and exhibit little or substantially no browning for a period of six weeks following preparation. In addition, the shelf-stable, yeastless sweet goods dough composition uses fats and oils that are substantially free of unsaturated trans-fatty acids; powdered eggs can be powdered whole eggs. The liquid sweetener comprises a blend of corn syrups, in a preferred embodiment, the blend of corn syrups comprises a mixture of about 1:1 of about 62 DE corn syrup and about 42% fructose corn syrup. The flour is an all-purpose flour substantially free of barley flour. The flavor additives can include chocolate chips, peanut flavored chips, and raisins. In some embodiments, the sweet goods dough may further include about 0.02 to about 1.0% vanilla flavoring. The sweet goods dough may be, in a preferred embodiment, a chocolate chip cookie dough comprising about 15 to about 25% by weight of chocolate chips.

In certain embodiments, the sweet goods dough may include one or more of the following additional ingredients: about 0.075 to about 1% by weight vanilla flavoring; about 0.25% by weight butter flavoring; about 8.42% by weight peanut butter; about 0.25% by weight peanut flavoring; about 0.2% by weight cinnamon; about 21.65% by weight oats; about 9% by weight raisins; or about 5.0% by weight glycerin.

Also provided herein is a method of making sweet goods doughs. In one embodiment, a process for making shelf-stable, yeastless sweet goods dough composition may include: (a) mixing together desired amounts of fats and oils, powdered eggs, sucrose, liquid sweetener, water, antimicrobial agent, salt, molasses, vanilla, butter flavor, and leavening agent to form a substantially homogeneous mixture; (b) blending the substantially homogeneous mixture with flour to form a dough composition; and (c) pumping said dough composition of step (b) to a packaging device. The sweet goods dough can include any of the above formulations.

In another embodiment, a shelf-stable, yeastless sweet goods dough composition may include other flavoring agents replacing either liquid or dry flavoring agents and/or possibly replacing a percentage of flour with other dry ingredients such as cocoa powder.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1-3 are a collection of photographs illustrating the reduced browning and “oiling out” of the present sweet goods dough as a function of time as compared with other sweet goods doughs.

### DETAILED DESCRIPTION

A shelf-stable sweet goods dough that resists microbial growth and the deteriorating effects of aging at ambient temperature is presented. The dough is formulated from conventional sweet goods ingredients that would be familiar to those skilled in the art; they are proportioned, however, such that a significant reduction in the undesirable effects of aging during storage at ambient temperature is realized. The present sweet goods dough is an improvement relative to known shelf-stable (e.g., as described in Kraklow and Kandler, U.S. Patent Application No. 20040219272, or Simms et al., European Patent Application No. 84402285.5) or refrigerated cookie doughs (e.g., Pillsbury® and Nestle® brand refrigerated cookie doughs) in such characteristics as color, texture, and oil stability, which subjectively form the basis of some consumer preferences. The shelf-stable dough described herein exhibits color stability superior to known doughs, exhibiting reduced color changes (e.g., browning) over time at ambient, i.e., room temperatures from about 65 to 75 degrees Fahrenheit (e.g., 65, 68, 70, 72 or 75 degrees Fahrenheit) or elevated temperatures. In addition, the present dough retains texture and pliability for extended periods from its formulation. A common problem in the shelf-stable dough marketplace is separation of fats and oils from the dough which may alter the formulated texture of the dough, affect the taste and moisture of the finished product, and present difficulties as a consumer handles a messy, oily product. The present dough exhibits markedly reduced fat and oil separation at ambient temperature for extended periods (e.g., 1 week to 3 months).

As one of skill in the art will recognize, sweet goods doughs can change color and develop off-flavors relative to their ‘just-made’ condition as a consequence of Maillard browning and other mechanisms. Maillard browning, a non-enzymatic reaction between simple sugars and amino acids in sweet goods dough formulations, may produce a variety of compounds having malodorous or unpalatable qualities. Such compounds may generally include: ketosamines, reductones and dehydro reductones, diacetyl, acetol, pyruvaldehydes, aldehydes, aldols, and melanoidins. The latter may produce such undesirable characteristics such as bitterness and off-aromas, which are not attributes of a quality bakery product. The present doughs can exhibit a slower rate of discoloration (e.g., as a result of browning, for example Maillard browning) as compared to known doughs, resulting in a continued pleasing appearance to consumers and stable flavor profile over time. As a consequence, the present doughs exhibit little (e.g., less than 5% change, less than 10% change, or less than 15% change) or substantially no browning over a period of one week or more (e.g., 7 days, 14 days, 30 days, 60 days or 90 days) at ambient temperature.

Water is an ingredient that may be present in sweet goods doughs, but previously it was thought that this should be avoided or minimized, as it lent itself toward microbial growth. The dryness of water-less dough was counteracted by inclusion of oils that lent the same or similar organoleptic properties such as “mouth feel.” However, consumers may find this to be undesirable from a health standpoint, and because the taste of the resulting product may be unpleasant. Water may be present due to the moisture content of individual ingredients such as flour, oils, or sweeteners. A significant contrast in the formulation of the present dough relative to ‘traditional’ sweet goods dough formulations is that water is added as an individual ingredient during the preparation (i.e., “neat” water, contrasting water contained in other ingredients). Including water as a separate ingredient may bear a direct relationship to the increased stability of the dough in terms of color and texture retention as a function of time.

One explanation for the observed effect may be that the present formulation has higher moisture content than that found in other dough products. As water is a by-product of the Maillard reaction, the law of mass action dictates that the reaction equilibrium will be shifted toward the reactants, and the rate of reaction for the Maillard process may be significantly slowed. The moisture content in the present sweet goods dough is primarily due to the addition of “neat” water, rather than water that is contained in other ingredients. “Neat” water implies typical sources of water, such as tap water, bottled or distilled water, and the like, and is added as a separate ingredient during the preparation process.

Also provided herein are dry blend and wet blend formulations for use in preparing the sweet good doughs. In some cases, water can be added to a dry blend formulation, a wet blend formulation, or a mixture of the two at a later time by the consumer, for example, to prepare the sweet goods dough prior to cooking.

### Compositions

Provided herein is a shelf-stable, yeastless sweet goods dough composition that includes: from about 8 to about 25% by weight of fats and oils (e.g., from about 10 to about 25%, from about 14 to about 23%, and from about 15 to about 20%); from about 0.5 to about 4% by weight powdered eggs (e.g., from about 1 to about 3%, from about 1.5 to about 2.5%; and from about 1.8 to about 2.1%); from about 5 to about 25% by weight of sucrose (e.g., from about 10 to about 25%, from about 15 to about 24%, from about 17 to about 23%, and from about 18 to about 22%); from about 6 to about 60% by weight of a liquid sweetener (e.g., from about 10 to about 50%, from about from about 6 to about 25%, from about 8 to about 18%, from about 12 to about 40%, and from about 9 to about 16%); from about 10 to about 40% by weight of flour (e.g., from about 10 to about 30%, from about 11 to about 33%, from about 12 to about 35%, and from about 14 to about 34%); from about 0 to about 10% by weight of neat water (e.g., 2 to about 8%, from about 3 to about 9%, and from about 4 to about 7%); from about 0 to about 1.0% by weight antimicrobial agent (e.g., from about 0.2 to about 0.8%, from about 0.4 to about 0.9%, from about 0.55 to about 0.85%, and from about 0.6 to about 0.8%); from about 0.2 to about 1.2% by weight salt (e.g., from about 0.2 to about 0.6%, from about 0.4 to about 0.8%, from about 0.25 to about 0.65%, and from about 0.3 to about 0.7%); from about 0 to about 5% by weight molasses (e.g., from about 0 to about 2.5%, from about 0.5 to about 4%, and from about 1.0 to about 3%); and from about 0.5 to about 2.0% by weight leavening agent (e.g., from about 0.6 to about 1.4%, from about 0.5 to about 1.5%, and from about 0.8 to about 1.2%). The total water content of the dough composition can be about 4.5% by weight; the pH of the dough can be about 6.8 to about 7.2, the dough can have a water activity in the range of about 0.65 to about 0.75, in some cases 0.72, and exhibit little or substantially no browning for a period of six weeks following preparation.

In some embodiments, a shelf-stable, sweet goods dough composition may include: from about 12 to about 23% by weight of fats and oils; from about 1.5 to about 3% by weight powdered sugar; from about 18 to about 23% by weight sucrose; from about 6 to about 20% by weight of a liquid sweetener; from about 10 to about 35% by weight flour; from about 2 to about 8% by weight water; from about 0.4 to about 1% by weight antimicrobial agent; from about 0.4 to about 1.0% by weight salt; from about 0 to about 3% molasses; and from about 0.5 to about 1.5% by weight leavening agent.

In another embodiment, a shelf-stable, yeastless sweet goods dough composition may include: 13.75% by weight of fats and oils; 2% by weight powdered eggs; 20.62% by weight of sucrose; 12% by weight of a liquid sweetener; 27.49% by weight of flour; 4.5% by weight of neat water; 0.59% by weight antimicrobial agent; 0.6% by weight salt; 0.2% by weight molasses; 0.2% by weight vanilla flavoring; 0.25% by weight butter flavoring; 1.32% by weight leavening agent; and 16.49% by weight flavor additives.

In certain embodiments, a shelf-stable, yeastless sweet goods dough composition may include: 14.13% by weight of fats and oils; 2.01% by weight powdered eggs; 20.19% by weight of sucrose; 12.04% by weight of a liquid sweetener; 28.27% by weight of flour; 3.51% by weight of neat water; 0.60% by weight antimicrobial agent; 0.85% by weight salt; 0.2% by weight molasses; 0.17% by weight vanilla flavoring; 0.50% by weight butter/vanilla flavoring; 1.32% by weight leavening agent; and 16.56% by weight flavor additives.

In further embodiments, a shelf-stable, yeastless sweet goods dough composition may include: 16.93% by weight of fats and oils; 1.64% by weight powdered eggs; 19.59% by weight of sucrose; 8.85% by weight of a liquid sweetener; 24.40% by weight of flour; 5.92% by weight of neat water; 0.55% by weight antimicrobial agent; 0.55% by weight salt; 1.50% by weight molasses; 0.73% by weight leavening agent; 7.66% by weight peanut butter; 2.55% by weight peanut flour; and 9.0% by weight flavor additives.

In other embodiments, a shelf-stable, yeastless sweet goods dough composition may include: 14.17% by weight of fats and oils; 2.05% by weight powdered eggs; 18.29% by weight of sucrose; 12.32% by weight of a liquid sweetener; 14.17% by weight of flour; 4.11% by weight of neat water; 0.62% by weight antimicrobial agent; 0.26% by weight salt; 2.56% by weight molasses; 0.1% by weight vanilla flavoring; 0.62% by weight leavening agent; 0.21% by weight cinnamon; 21.25% by weight oats; and 9.25% by weight raisins.

In another embodiment, a shelf-stable, yeastless sweet goods dough composition may include: 20.92% by weight of fats and oils; 2.10% by weight powdered eggs; 20.91% by weight of sucrose; 16.0% by weight of a liquid sweetener; 33.33% by weight of flour; 5.0% by weight of neat water; 0.59% by weight antimicrobial agent; 0.5% by weight salt; 0.063% by weight butter/vanilla flavoring; and 0.59% by weight leavening agent.

In some embodiments, a shelf-stable, yeastless sweet goods dough composition includes: 20.10% by weight of fat and oils; 17.53% by weight of sucrose; 10.48% by weight of a liquid sweetener; 0.70% by weight leavening agent; 0.23% by weight of salt; 3.49% by weight powdered eggs; 5.82% by weight of neat water; 0.24% by weight vanilla flavoring; 4.66% by weight of cocoa; 17.53% by weight flour; and 19.23% by weight of chocolate chips.

In the above embodiments, the total water content of the dough composition can be about 4.5% by weight; the pH of the dough can be about 6.8 to about 7.2, the dough can have a water activity in the range of about 0.65 to about 0.75, in some cases 0.72, and exhibit little or substantially no browning for a period of six weeks following preparation. In addition, the shelf-stable, yeastless sweet goods dough composition uses fats and oils that are substantially free of unsaturated trans-fatty acids; powdered eggs can be powdered whole eggs.

The liquid sweetener can comprise a blend of corn syrups. In some embodiments, the blend of corn syrups can be a binary mixture (i.e. can comprise two corn syrups). In some embodiments, the blend of corn syrups can comprise a mixture of about 1:1 of 62 DE corn syrup and about 42% fructose corn syrup. In some embodiments, the flour is an all-purpose flour substantially free of barley flour. In some embodiments, some or all of the flour can be corn flour or corn meal. In some embodiments, the flavor additives can include chocolate chips, white chocolate chips, butterscotch flavored chips, peanut flavored chips, dried cranberries, raisins, and nuts. In some embodiments, the sweet goods dough may further include about 0.02 to about 1.0% vanilla flavoring. The sweet goods dough may be, in a preferred embodiment, a chocolate chip cookie dough comprising about 15 to about 25% by weight of chocolate chips.

In certain embodiments, the sweet goods dough may include one or more of the following additional ingredients: about 0.075 to about 1% by weight vanilla flavoring; about 0.25% by weight butter flavoring; about 8.42% by weight peanut butter; about 0.25% by weight peanut flavoring; about 0.2% by weight cinnamon; about 21.65% by weight oats; about 9% by weight raisins; or about 5.0% by weight glycerin. In another embodiment, a shelf-stable, yeastless sweet goods dough composition may include other flavoring agents replacing either liquid or dry flavoring agents and/or possibly replacing a percentage of flour with other dry ingredients such as cocoa powder.

Also provided are yeastless dry blend compositions for preparing sweet goods doughs. A dry blend formulation can comprise two or more of the dry ingredients of a sweet goods dough. A yeastless dry blend formulation may require addition of water and optionally other liquid ingredients of a sweet goods dough to the dry blend to prepare a sweet goods dough prior to cooking of the sweet goods dough. In some embodiments, the water may be added by the consumer prior to cooking of the sweet goods dough.

In some embodiments, a yeastless sweet goods dough dry blend composition includes: from about 2.5 to about 5.5% by weight powdered eggs; from about 28% to about 34.5% by weight of sucrose; about 54.5% to about 68% by weight of flour; from about 0 to about 1.4% by weight antimicrobial agent; about 1% to about 1.6% by weight salt; and from about 0 to about 2.7% by weight leavening agent.

In some embodiments, a yeastless sweet goods dough dry blend composition includes: from about 4.5 to about 5% by weight powdered eggs; from about 35.5 to about 58.5% by weight sucrose; from about 32.5 to about 54.5% by weight flour; from about 1.3% to about 1.6% by weight antimicrobial agent; from about 1.3% to about 1.6% by weight salt; and from about 1.6% to about 2.3% by weight of leavening agent.

In some embodiments, a yeastless sweet goods dough dry blend composition includes additional ingredients, for example, flavor additives including, for example, oats, cinnamon, chocolate chips, white chocolate chips, butterscotch flavored chips, peanut flavored chips, dried cranberries, raisins, and nuts. In some embodiments, the flour is an all-purpose flour substantially free of barley flour. In some embodiments, some or all of the flour can be corn flour or corn meal. In some embodiments, a yeastless sweet goods dough dry blend composition may include other flavoring agents replacing either liquid or dry flavoring agents and/or possibly replacing a percentage of flour with other dry ingredients such as cocoa powder.

In some embodiments, a yeastless sweet goods dough wet blend composition can be prepared. Such a wet blend can include two or more of the wet ingredients of a sweet goods dough composition, with the exception of water. In some embodiments, the water may be added to a wet blend composition by the consumer prior to preparation and cooking of the sweet goods dough. In some embodiments, a yeastless sweet goods dough wet blend formulation may require addition of water and optionally other dry ingredients of a sweet goods dough to the wet blend to prepare a sweet goods dough prior to cooking of the sweet goods dough.

In some embodiments, a yeastless sweet goods dough wet blend composition includes: from about 27.5 to about 57.5% by weight of fats and oils; from about 42.5 to about 67% by weight of a liquid sweetener; and from about 0 to about 6% by weight molasses. In some embodiments, a yeastless sweet goods dough wet blend composition includes: from about 50 to about 67% by weight of fats and oils; from about 33 to about 43.5% by weight of a liquid sweetener; and from about 0 to about 6.5% by weight molasses.

In some embodiments, a yeastless sweet goods dough wet blend composition includes additional ingredients, for example, vanilla flavoring, butter flavoring, peanut flavoring, and glycerin.

### Methods for Making

In a one embodiment, the present sweet goods dough is formulated in the following manner. Shortening, powdered whole eggs, sucrose, corn syrups, water, an antimicrobial agent (potassium sorbate), salt, molasses, vanilla, butter flavor, and encapsulated soda are combined and mixed in a mixer. In some embodiments, the shortening is fully hydrogenated, trans-fat free shortening, labeled as ADM 106-100; the powdered whole eggs are dried egg white plus dried egg yolk in proportions equal to that contained in one egg, from Stonstegard; the sucrose is ChiSweet extra fine granulated sucrose; the corn syrups are 62 DE corn syrup, from ChiSweet, and 42% fructose corn syrup, from ChiSweet; the water is tap water; the potassium sorbate is from ChiSweet or DMH Ingredients; the salt is flour salt from Cargill; the molasses is Robust Molasses from ChiSweet; the vanilla is Vanilla FAGR0883, from Wild Flavors; the butter flavor is Butter 4430, from Edlong; the butter/vanilla flavor is 072-00434 from Cargill; and the encapsulated soda is 50% encapsulated, from Watson Foods. Next, flour is added to the mixture. In another embodiment, the flour is “hotel and restaurant flour (all purpose),” from Conagra, with a protein content of about 10 to about 11%. The mixture is mixed until well blended. This formulation forms the “base” of the sweet goods dough to which can then be added other flavorings or additives, for example, nuts, chips or chunks of other sweet goods products such as chocolate chips. The proportions of ingredients for the above preferred embodiment are presented for a chocolate chip cookie dough in Example 1.

As previously mentioned, microbial growth in sweet goods doughs may be significantly reduced by controlling the environment in which microbes are likely to proliferate. Control may be accomplished by regulating the pH of the dough, maintaining a water activity level below threshold values, or adding ingredients with water scavenging properties such as barley flour, which contains beta glucans, a known moisture-scavenger. While this ingredient may be beneficial in moisture reduction, consumers have historically not favored the taste and texture of barley flours over their traditional counterparts. The flour used in the present invention is substantially free of barley flour.

As used herein, “water activity” is defined as the ratio of vapor pressure of a solution or mixture to that of pure water at a specific temperature. Water activity may be considered a measure of free water in the dough mixture. Water activity may be assessed by measuring the equilibrium vapor pressure of a mixture at a particular temperature and expressing that value as a ratio of the mixture equilibrium vapor pressure to the equilibrium water vapor pressure of water at that temperature. The present sweet goods doughs preferably have water activity levels between about 0.65 and about 0.75 (e.g., 0.65, 0.66, 0.67, 0.68, 0.69, 0.70, 0.71, 0.72, 0.73, 0.74, and 0.75), and preferably the present doughs have a water activity level of about 0.72.

As used herein, “percent by weight” means “weight percent” and vice versa. As used herein, “fats and oils” means fats and/or oils which can be substantially free of trans-fatty acids, e.g., “trans-free” fats and oils. As used herein, “yeastless” means a dough composition that is essentially free of yeast and does not contain an amount of active yeast effective to create any appreciable amount of leavening of the dough composition prior to baking. As used herein, “powdered eggs” means whole eggs which have been dried and contain substantially no water content. As used herein, “liquid sweetener” means liquids which add a sweetening flavor, such as corn syrups, and in a general sense, corn syrups with a DE (dextrose equivalent) range of between 55-62 DE, and 42% fructose corn syrup. As used herein, “flour” refers to flour all-purpose flour, typically with a protein content of 10-11%. In some embodiments, some or all of the “flour” can be replaced by corn flour or corn meal.

Also included in the present application is a method by which to cook any of the sweet goods dough products described herein. The sweet goods dough products may be baked to a desirable consistency using either microwave energy or convection/conventional oven heating. If using a microwave, the sweet goods dough product may be cooked on a plate, napkin, paper towel, plastic container, glass cooking dish, metallized microwave susceptor film, paper container, or other specialized or accepted microwave-safe cooking receptacle.

A sweet goods dough dry blend composition may be prepared by mixing two or more of the dry ingredients of a sweet goods dough. Similarly, a sweet goods dough wet blend composition may be prepared by mixing two or more of the wet ingredients, with the exception of water, of a sweet goods dough. When preparing a sweet goods dough from a dry blend composition and/or a wet blend composition, it may be necessary to add water to the composition prior to cooking. In some embodiments, a dry blend composition and a wet blend composition are mixed to prepare a sweet goods dough. In some embodiments, water is added to the mixture of a dry blend composition and a wet blend composition. In some embodiments, a dry blend composition is mixed with one or more wet ingredients (e.g., water, liquid sweetener, fats/oils, and molasses) to prepare a sweet goods dough. In some embodiments, a wet blend composition is mixed with one or more dry ingredients (e.g., flour, sucrose, powdered eggs, and salt) to prepare a sweet goods dough.

### Dough Qualities

Effects of food-product deterioration can be measured by a variety of methods. A food product and the effect of a particular ingredient or process can be evaluated by examining the sensory attributes of a food product. Sensory attributes include, for example, color, tenderness, amount of cracking, gumminess, chewiness, moistness, hardness, flavor quality, mouth coating, finger oiliness, and graininess. Sensory attributes of food products are usually determined by a trained sensory panel. A sensory panel refers to those individuals involved in the sensory evaluation of the edible food product. Panelists are pre-screened to be able to detect the sensory differences in the particular product tested and are trained in sensory descriptions. A panel provides qualitative and quantitative scores for the sensory evaluation that are referenced against calibrated standards. Shelf-life stability of a food product can be determined by analyzing food samples made by a particular method, and then packaged and stored in an oven at an elevated temperature to accelerate aging. “Shelf-life” is the time it takes for a food product to degrade to a set sensory score.

To facilitate the testing process, the present sweet goods doughs can be kept in a sealed container environment at ambient temperature. In some cases, doughs can be stored at higher than ambient temperatures to accelerate the browning process (if any), and compared once a week for a period of 1 to 6 months (e.g., 1, 2, 3, 4, 5, 6 months). The person trained in detecting sensory attributes can record their observations on the appearance of the dough and can photograph the doughs to document differences, e.g., color or oiling differences.

Doughs may be subjected to tests by a six-member sensory panel trained on the ranking of color and other product attributes. Panelists may be presented with an identified reference previously rated for color attributes which could serve both as the identified reference and ‘blind,’ as a variable to check the sensory capability of the panel as a whole. A 60-point linear scale may be used for the rating of dough and baked cookie color for the shelf life study. A score of “0” may equate to dough with very light color while dough with a “60” would be dark in color. Cookies having a “0” rating may be light brown in color whereas those with a “60” rating may be dark brown in color.

The present sweet goods dough exhibits an improved texture, both initially and over time, as compared to known shelf-stable or refrigerated doughs. The present dough exhibits an improved working texture after preparation, resulting in improved processability during large-scale production, and ease of use by the consumer relative to known doughs. This improved texture persists over time as compared to known doughs. One of the benefits of the present invention may be that a consumer need not wait while an analogous refrigerated dough warms to ambient temperature before scooping or managing the dough. The texture of a sweet goods dough may be evaluated by a panel of testers trained in sensory descriptions. The panel may be asked to rate the relative ease or difficulty in managing (e.g., scooping) the dough at ambient or refrigerated temperature, using a number scale from 1-5, where 1=very easy and virtually effortless, and 5=very firm, requiring pressing back and forth to work through the dough.

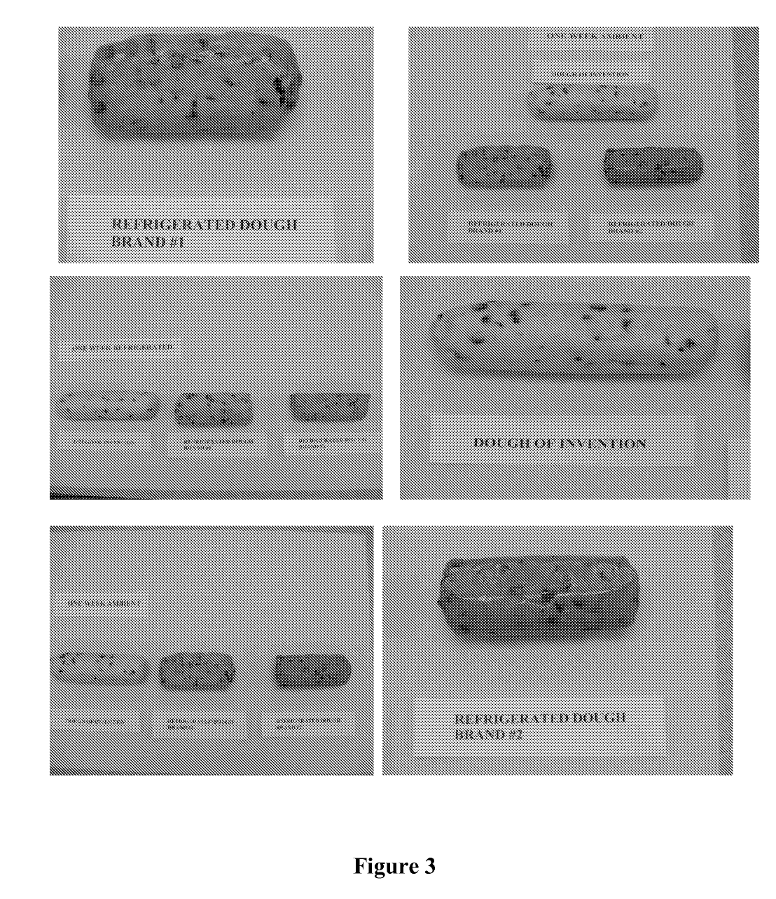

The sweet goods dough can also exhibit a reduced oiliness, both initially and over time, as compared to known shelf-stable or refrigerated doughs. Shelf-stable doughs are known to “oil-out” over time, meaning that the once-homogenized oils separate from the mixture and tend to pool on top of a container of dough, for example. The extent to which doughs oil out may be measured by a variety of techniques. For example, a sensory panel trained in detecting the effects of the oiling out process may be employed to rate the degree of oiling out for doughs over a period of time, i.e., 0, 1, 2, 3 weeks or more. Alternatively, a more quantitative method may be used which measures the amount of oil that separates from the dough mixture over time. This type of technique may involve, for example, collecting (e.g., “wicking”) the pooled oils on the top of a sample of dough into a cloth or other oil-absorbing medium and weighing the amount of oil collected. Oiling out also may be detected by simple visual inspection of a dough surface. Dough surfaces exhibiting oil-out typically exhibit a “sheen” that is readily apparent to the human eye (e.g., compare FIG. 3(D) with FIGS. 3(A, B, E, and F)).

### EXAMPLES

### 1. Preparation of a Chocolate-Chip Cookie Sweet Goods Dough

A chocolate-chip cookie dough was prepared according to the following procedure. The dough exhibited marked resistance to spoilage and other aforementioned deleterious effects. Ingredient proportions are listed as percent by weight of the final weight of the dough.

TABLE 1
Ingredient list for a chocolate-chip cookie sweet goods dough.

| Ingredient | Source | Weight % |
|---|---|---|
| STEP 1 | | |
| Trans-fat-free | ADM 106-100 | 13.75 |
| shortening | | |
| Powdered whole | Primera, Inc. | 2 |
| eggs | | |
| Granulated sucrose | Domino extra-fine | 20.62 |
| Sweetener blend | 62 DE corn syrup; | 11.99 |
| | 42% fructose corn syrup; | |
| | Corn Products | |
| Water | Tap | 4.5 |
| Potassium sorbate | DMH Ingredients | 0.59 |
| Salt | Flour salt, Cargill | 0.6 |
| Molasses | Robust Molasses, ChiSweet | 0.2 |
| Vanilla | Vanilla FAGR0883, Wild Flavors | 0.2 |
| Butter flavor | Butter 4430, Edlong | 0.25 |
| Encapsulated soda | 50% Encapsulated, Watson Foods | 1.32 |
| STEP 2 | | |
| Flour | Hotel and restaurant flour (all-purpose); | 27.49 |
| | protein content 10-11%, Conagra | |
| STEP 3 | | |
| Chocolate chips | Semisweet, 1000 count, T157, Wilbur | 16.49 |
| | TOTAL: | 100 |

The ingredients listed under STEP 1 in Table 1 were placed in a Kitchen Aide bowl, model K5SS and mixed on low speed for 1 minute, then on high speed for 3 minutes. Flour (STEP 2 in Table 1) was added to the ingredients in STEP 1 and mixed on low speed for 4 minutes for commercial practice (15 seconds on low then two minutes on medium for laboratory practice). Chocolate chips were added to the mixture (STEP 3 in Table 1) comprising the ingredients of Step 1 and Step 2. The mixture was mixed on low speed for one minute for commercial practice (30 seconds on low in laboratory practice). The resulting dough had a water activity of less than 0.72, a pH of 6.8-7.2, and an estimated moisture content of 11.3%.

### 2. Preparation of a Chocolate-Chip Cookie Sweet Goods Dough

A chocolate-chip cookie dough was prepared according to the following procedure. The dough exhibited marked resistance to spoilage and other aforementioned deleterious effects. Ingredient proportions are listed as percent by weight of the final weight of the dough.

TABLE 2
Ingredient list for a chocolate-chip cookie sweet goods dough.

| Ingredient | Source | Weight % |
|---|---|---|
| Step 1 | | |
| Shortening, 106-100 low trans | ADM | 14.13 |
| Extra fine granulated sucrose | ChiSweet | 20.19 |
| Step 2 | | |
| Powdered whole eggs | Stonstegard | 2.01 |
| Corn Syrup, 42% fructose | ChiSweet | 6.02 |
| Corn Syrup, 62DE | ChiSweet | 6.02 |
| Water | Tap | 3.51 |
| Potassium sorbate | ChiSweet | 0.60 |
| Salt, flour | Cargill | 0.85 |
| Molasses | ChiSweet | 0.20 |
| Vanilla flavor, FAGR883 | Wild Flavors | 0.17 |
| Butter/vanilla flavor, 072-00434 | Cargill | 0.050 |
| Encapsulated soda, 50% | Watson Foods | 1.32 |
| BHT | Eastman Chemical | 0.003 |
| Sweet brown butter, FAGU156 | Wild Flavors | 0.09 |
| Step 3 | | |
| Hotel & restaurant flour | Conagra | 28.27 |
| Step 4 | | |
| Semisweet chocolate chips 67336 | Blommer | 8.28 |
| 1M ct | | |
| Semisweet chocolate chips, no | Blommer | 8.28 |
| code 2M ct | | |
| | TOTAL: | 100.00 |

The ingredients listed under Step 1 in Table 2 were placed in a Kitchen Aide bowl, model K5SS and mixed on low speed for 1 minute, then on high speed for 5 minutes, or until a uniform mix is achieved. The ingredients from Step 2 were added and mixed on low speed for 1 minute and high speed for 2 minutes. Flour (Step 3, Table 2) was added to the ingredients in Step 1 and Step 2 and mixed on low speed for 4 minutes. Chocolate chips according to STEP 4 in Table 2 were added to the mixture including the ingredients of Step 1-3. The mixture was mixed on low speed for 30 seconds. The resulting dough had a density of 1.04 g/cm², water activity of less than 0.72, a pH of 6.8-7.2, and an estimated moisture content of 11.3%.

### 3. Preparation of a Peanut-Butter Cookie Sweet Goods Dough

A peanut-butter cookie dough was prepared according to the following procedure. The dough exhibited marked resistance to spoilage and other aforementioned deleterious effects. Ingredient proportions are listed as percent by weight of the final weight of the dough.

TABLE 3
Ingredient list for a peanut-butter cookie sweet goods dough.

| Ingredient | Source | Weight % |
|---|---|---|
| Step 1 | | |
| Shortening, | ADM | 16.93 |
| 106-100 low trans | | |
| Extra fine granulated | ChiSweet | 19.59 |
| sucrose | | |
| Peanut butter, creamy | Algood, Dawn Food | 7.66 |
| | Ingredients | |
| Step 2 | | |
| Powdered whole eggs | Sonstegard | 1.64 |
| Part. defatted peanut flour #522857 | Golden Peanut Company | 2.55 |
| Molasses, Robust | ChiSweet | 1.50 |
| Corn syrup, 62 DE | Corn Products | 4.425 |
| Corn syrup, 42% fructose | Corn Products | 4.425 |
| Water | | 5.92 |
| Encapsulated soda, 50% | Watson Foods | 0.73 |
| Flour salt | Cargill | 0.55 |
| Potassium sorbate | ChiSweet - DMH | 0.55 |
| Color #111 | D D Williamson | 0.15 |
| Step 3 | | |
| Hotel & restaurant flour | ConAgra | 24.40 |
| Step 4 | | |
| Peanut flavored chips, | ADM | 9.00 |
| 855081 | | |
| | TOTAL: | 100.00 |

Ingredients from Step 1 in Table 3 were placed in a Kitchen Aide bowl, model K5SS and mixed on the lowest speed setting for about 1 minute. The mixing speed was then increased to high speed and creamed for 5 minutes, or until a uniform mix is achieved. The ingredients listed in Step 2 in Table 3 were then added and mixed on the lowest speed for about 1 minute, then on high speed to blend for 2 minutes. The flour in Step 3 of Table 3 was then added and the mixture was mixed on low speed for 4 minutes. Finally, the peanut flavored chips in Step 4 were added and the mixture was mixed for 30 seconds on lowest speed.

A level #40 ice cream scoop (approximately 1.0 oz) of the resulting dough was deposited on an aluminum baking sheet and baked for 10-12 minutes at 350° F. The resulting product was cooled for 2 minutes, removed from the baking sheet and transferred to a cooling rack.

### 4. Preparation of an Oatmeal Raisin Cookie Sweet Goods Dough

An oatmeal raisin cookie dough was prepared according to the following procedure. The dough exhibited marked resistance to spoilage and other aforementioned deleterious effects. Ingredient proportions are listed as percent by weight of the final weight of the dough.

TABLE 4
Ingredient list for an oatmeal raisin cookie sweet goods dough.

| Ingredient | Source | Weight % |
|---|---|---|
| STEP 1 | | |
| Shortening, 106-100 low trans | ADM | 14.17 |
| Extra fine granulated sucrose | ChiSweet - Cargill | 18.29 |
| STEP 2 | | |
| Molasses, robust | ChiSweet | 2.56 |
| Corn syrup, 62 DE | ChiSweet | 6.16 |
| Corn syrup, 42% fructose | ChiSweet | 6.16 |
| Powdered whole egg | Sonstegard | 2.05 |
| Water | Tap | 4.11 |
| Vanilla, FAGR883 | Wild Flavors | 0.10 |
| Potassium sorbate | ChiSweet | 0.62 |
| Encapsulated soda, 50% | Watson Foods | 0.62 |
| Salt, flour | Cargill | 0.26 |
| Cinnamon, ground 2.0 60 mesh | Dawn Foods | 0.21 |
| STEP 3 | | |
| Flour, hotel & restaurant | ConAgra | 14.17 |
| Oats, old-fashioned | Dawn Foods | 21.25 |
| STEP 4 | | |
| Raisins, midget | Dawn Foods | 9.25 |
| | TOTAL: | 100.00 |

Ingredients from Step 1 in Table 4 were creamed in a Kitchen Aide bowl, model K5SS on low speed for 1 minute, then on high speed for 5 minutes, or until a uniform mix is achieved. The ingredients listed in Step 2 of Table 4 were added to the ingredients listed in Step 1 and mixed on low speed for 1 minutes and then on high speed for 2 minutes. The flour and oats in Step 2 were added and the mixture was mixed on low speed for 4 minutes. Raisins (Step 4) were added to the mixture and mixed on low speed for 30 seconds.

A level #40 ice cream scoop (approximately 1.0 oz) of the resulting dough was deposited on an aluminum baking sheet and baked for 10-12 minutes at 350° F. The resulting product was cooled for 2 minutes, removed from the baking sheet and transferred to a cooling rack.

### 5. Preparation of a Sugar Cookie Sweet Goods Dough

A sugar cookie dough was prepared according to the following procedure. The dough exhibited marked resistance to spoilage and other aforementioned deleterious effects. Ingredient proportions are listed as percent by weight of the final weight of the dough.

TABLE 5
Ingredient list for a sugar cookie sweet goods dough.

| Ingredient | Source | Weight % |
|---|---|---|
| Step 1 | | |
| Shortening, 106-100 low trans | ADM | 20.92 |
| Extra Fine granulated sucrose | ChiSweet | 20.91 |
| Step 2 | | |
| Powdered whole egg | Primera | 2.10 |
| Corn syrup, 62 DE | ChiSweet | 8.00 |
| Corn syrup, 42% fructose | ChiSweet | 8.00 |
| Water | Tap | 5.00 |
| Potassium Sorbate | ChiSweet | 0.59 |
| Salt, flour | Cargill | 0.50 |
| Butter/vanilla flavor, 072-00434 | Cargill | 0.063 |
| Encapsulated soda, 50% | Watson Foods | 0.59 |
| Step 3 | | |
| Hotel & restaurant flour | ConAgra | 33.33 |
| | TOTAL: | 100.000 |

Ingredients from Step 1 in Table 5 were placed in a Kitchen Aide bowl, model K5 SS, and mixed on the lowest speed for 1 minute, then on high speed to cream for 3 minutes, or until a uniform mixture is achieved. The ingredients listed in Step 2 of Table 5 was added to the mixer with the ingredients from Step 1 and mixed on lowest speed for 1 minute, followed by blending at high speed for 2 minutes. The flour in Step 3 of Table 5 was added to the mixer with the ingredients from Step 1 and 2 and mixed on lowest speed for 4 minutes.

A level #40 ice cream scoop (approximately 1.0 oz) of the resulting dough was deposited on an aluminum baking sheet and baked for 10-12 minutes at 350° F. The resulting product was cooled for 2 minutes, removed from the baking sheet and transferred to a cooling rack.

### 6. Sensory Panel Results on Dough Color Changes as a Function of Time

Chocolate chip cookie doughs as described in Example 2 above were subjected to tests by a six-member sensory panel trained on the ranking of color and other product attributes. Panelists were presented with an identified reference previously rated for color attributes which served both as the identified reference and ‘blind,’ as a variable to check the sensory capability of the panel as a whole. A 60-point linear scale was used for the rating of dough and baked cookie color for the shelf life study. A score of “0” equated to dough with very light color while dough with a “60” was dark in color. Cookies having a “0” rating were light brown in color whereas those with a “60” rating were dark brown in color. At the beginning of the study, the panelists assigned a dough color value of “15” to the dough and the baked cookie a “20”. Results for the products stored at 72 degrees F. are shown in Table 6.

TABLE 6
Present dough and cookie color as a function of time.

| Shelf Life Age | Dough Color | Baked Cookie Color |
|---|---|---|
| Time zero | 15 | 20 |
| Two weeks | 9.0 | 15.3 |
| Four weeks | 15.8 | 18.2 |
| Six weeks | 16.3 | 18.3 |

### 7. Sensory Panel Results on Dough Manageability

The texture of the present chocolate chip cookie sweet goods dough was evaluated by a panel of testers trained in sensory descriptions. The panel was asked to rate the relative ease or difficulty in managing (e.g. scooping) the dough at ambient or refrigerated temperature, using a number scale from 1-5, where 1=very easy and virtually effortless, and 5=very firm, requiring pressing back and forth to work through the dough.

TABLE 7
Dough manageability test results.

| Dough | Temperature | Rating |
|---|---|---|
| Present invention | Ambient | 1 |
| Pillsbury | Ambient | 1 |
| Nestle | Ambient | 1 |
| Nestle | Refrigerator temp | 5 |
| Pillsbury | Refrigerator temp | 3 |

Results of dough manageability tests for the present invention and other marketed brands are shown in Table 7. All of the doughs at ambient temperature were rated as “1,” meaning “very easy and virtually effortless,” however those at refrigerator temperature were significantly more difficult to manage.

### 8. Change (if any) in Sweet Goods Dough Color as a Function of Time

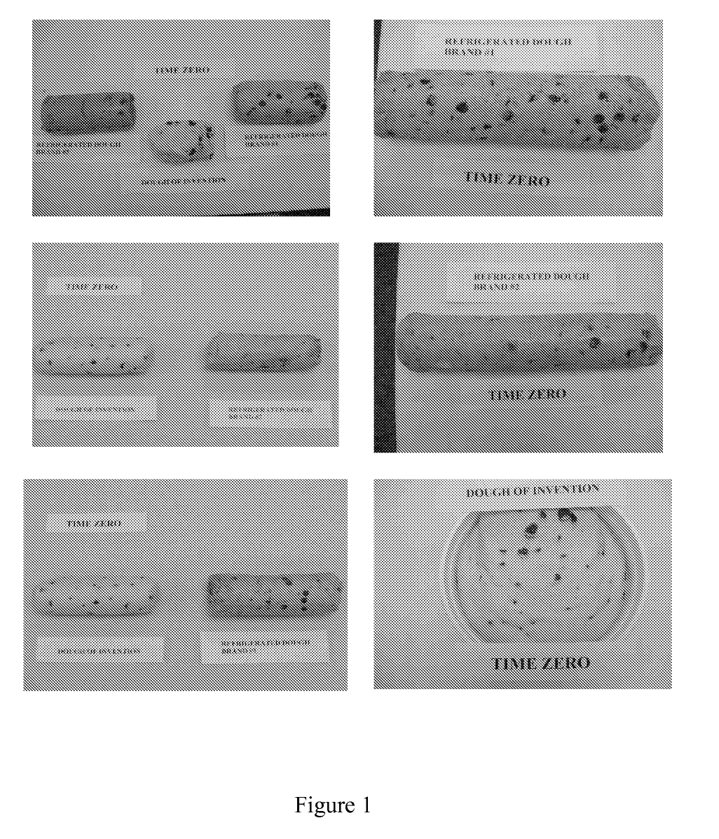

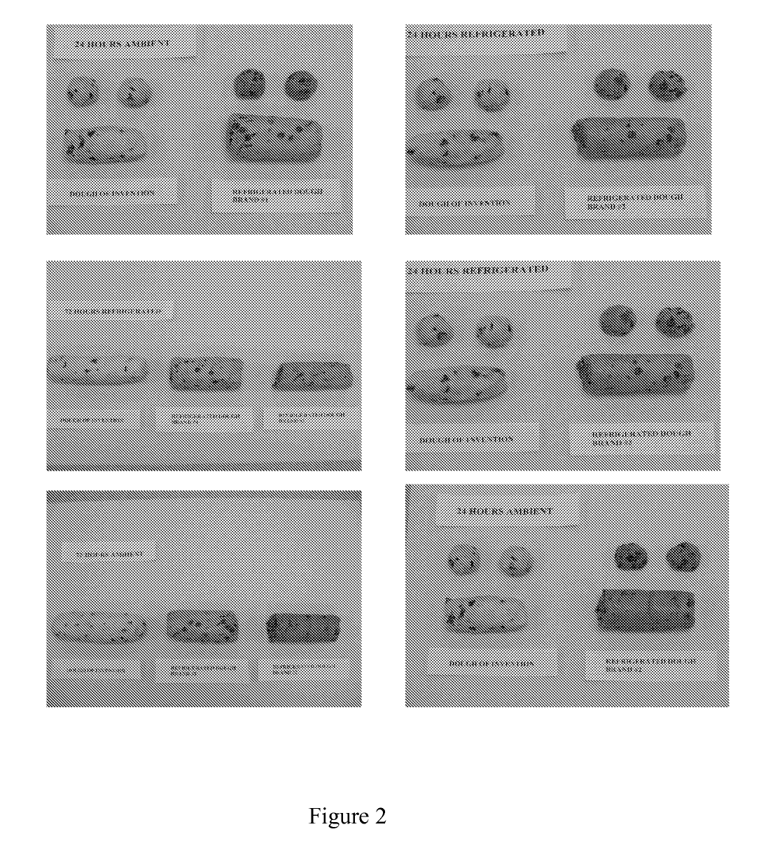

FIGS. 1 and 2 show photographic results of the discoloration (if any) and “oiling out” (if any) effects of aging for the present dough invention and competitor refrigerated doughs as a function of time. FIG. 1, photograph A shows three doughs, the “dough of invention,” “brand 1,” and “brand 2” photographed at a given time to track the progress of color changing (if any) relative to one another. FIG. 2 presents photographs of the same doughs after a set amount of time, indicated on each photograph. “Ambient” and “Refrigerated” refer to the temperature at which the samples were held during the entire course of the experiment.

### 9. Change (if any) in Dough Surface Oil Content

Separation of fats and oils from the dough mixture were qualitatively assessed by photography as shown in FIG. 3. Photograph E shows the degree to which the brand #1 and brand #2 doughs (competitor's products from Nestle® and Pillsbury®) have “oiled out” and changed color relative to the present invention “dough of invention” one week after production at ambient temperature. Photograph C shows the degree to which brand #1 and brand #2 have “oiled out” and changed color relative to the present invention “dough of invention” one week after production when the doughs were sustained at refrigerated temperatures.

### 10. Preparation of a Brownie Sweet Goods Dough

A brownie dough was prepared according to the following procedure. The dough exhibited marked resistance to spoilage and other aforementioned deleterious effects. Ingredient proportions are listed as percent by weight of the final weight of the dough.

TABLE 8
Ingredient list for a brownie sweet goods dough.

| Ingredient | Source | Weight % |
|---|---|---|
| Step 1 | | |
| Low trans shortening, 106-100 | ADM | 20.10 |
| Extra fine granulated sucrose | United Sugars | 17.53 |
| Corn syrup, 42% fructose | Chicago Sweeteners | 5.24 |
| Corn syrup, 62DE | Chicago Sweeteners | 5.24 |
| Encapsulated soda, 50% | Watson | 0.70 |
| Flour salt | Cargill | 0.23 |
| Powdered whole egg | Primera | 3.49 |
| Water | Tap | 5.82 |
| Vanilla, FAGR883 | Wild | 0.24 |
| Step 2 | | |
| Cocoa, Russet Plus | Wilbur/ADM | 4.66 |
| Defender H&R flour | Cargill | 17.53 |
| Step 3 | | |
| Chocolate chips 1M, 67336 | Blommer | 19.23 |
| | TOTAL | 100.00 |

Ingredients from Step 1 in Table 8 were placed in a Kitchen Aide bowl, model K5SS, and mixed on the lowest speed for 1 minute, then on high speed to cream for 3 minutes, or until a uniform mixture is achieved. The ingredients listed in Step 2 of Table 8 was added to the mixer with the ingredients from Step 1 and mixed on lowest speed for 1 minute, followed by blending at high speed for 2 minutes. The chocolate chips in Step 3 of Table 8 were added to the mixer with the ingredients from Step 1 and 2 and mixed on lowest speed for 4 minutes.

### 11. A Chocolate-Chip Cookie Sweet Goods Dough Dry and Wet Blend Formulation

A dry and wet blend of a chocolate-chip cookie dough is prepared using the following list of ingredients. Ingredient proportions are listed as percent by weight of the final weight of the dry and wet composition respectively.

TABLE 9
Ingredient list for a chocolate-chip
cookie sweet goods dough dry blend.

| Ingredient | Source | Weight % |
|---|---|---|
| Powdered whole | Primera, Inc. | 2.89 |
| eggs | | |
| Granulated sucrose | Domino extra-fine | 29.84 |
| Potassium sorbate | DMH Ingredients | 0.85 |
| Salt | Flour salt, Cargill | 0.87 |
| Encapsulated soda | 50% Encapsulated, Watson Foods | 1.91 |
| Flour | Hotel and restaurant flour (all-purpose); | 39.78 |
| | protein content 10-11%, Conagra | |
| Chocolate chips | Semisweet, 1000 count, T157, Wilbur | 23.86 |
| | TOTAL: | 100 |

TABLE 10
Ingredient list for a chocolate-chip
cookie sweet goods dough wet blend.

| Ingredient | Source | Weight % |
|---|---|---|
| Trans-fat-free | ADM 106-100 | 52.10 |
| shortening | | |
| Sweetener blend | 62 DE corn syrup; | 45.43 |
| | 42% fructose corn syrup; | |
| | Corn Products | |
| Molasses | Robust Molasses, ChiSweet | 0.76 |
| Vanilla | Vanilla FAGR0883, Wild Flavors | 0.76 |
| Butter flavor | Butter 4430, Edlong | 0.95 |
| | TOTAL: | 100 |

### 12. A Chocolate-Chip Cookie Sweet Goods Dough Dry and Wet Blend Formulation

A dry and wet blend of a chocolate-chip cookie dough is prepared using the following list of ingredients. Ingredient proportions are listed as percent by weight of the final weight of the dry and wet composition respectively.

TABLE 11
Ingredient list for a chocolate-chip
cookie sweet goods dough dry blend.

| Ingredient | Source | Weight % |
|---|---|---|
| Extra fine granulated sucrose | ChiSweet | 28.92 |
| Powdered whole eggs | Stonstegard | 2.88 |
| Potassium sorbate | ChiSweet | 0.86 |
| Salt, flour | Cargill | 1.22 |
| Encapsulated soda, 50% | Watson Foods | 1.89 |
| BHT | Eastman Chemical | 0.004 |
| Hotel & restaurant flour | Conagra | 40.50 |
| Semisweet chocolate chips 67336 | Blommer | 11.86 |
| 1M ct | | |
| Semisweet chocolate chips, no | Blommer | 11.86 |
| code 2M ct | | |
| | TOTAL: | 100.00 |

TABLE 12
Ingredient list for a chocolate-chip
cookie sweet goods dough wet blend.

| Ingredient | Source | Weight % |
|---|---|---|
| Shortening, 106-100 low trans | ADM | 52.96 |
| Corn Syrup, 42% fructose | ChiSweet | 22.56 |
| Corn Syrup, 62DE | ChiSweet | 22.56 |
| Molasses | ChiSweet | 0.75 |
| Vanilla flavor, FAGR883 | Wild Flavors | 0.64 |
| Butter/vanilla flavor, 072-00434 | Cargill | 0.19 |
| Sweet brown butter, FAGU156 | Wild Flavors | 0.34 |
| | TOTAL: | 100.00 |

### 13. A Peanut-Butter Cookie Sweet Goods Dough Dry and Wet Blend Formulation

A dry and wet blend of a peanut butter cookie dough is prepared using the following list of ingredients. Ingredient proportions are listed as percent by weight of the final weight of the dry and wet composition respectively.

TABLE 13
Ingredient list for a peanut-butter
cookie sweet goods dough dry blend.

| Ingredient | Source | Weight % |
|---|---|---|
| Extra fine granulated | ChiSweet | 33.20 |
| sucrose | | |
| Powdered whole eggs | Sonstegard | 2.78 |
| Part. defatted peanut flour | Golden Peanut Company | 4.32 |
| #522857 | | |
| Encapsulated soda, 50% | Watson Foods | 1.24 |
| Flour salt | Cargill | 0.93 |
| Potassium sorbate | ChiSweet - DMH | 0.93 |
| Hotel & restaurant flour | ConAgra | 41.35 |
| Peanut flavored chips, | ADM | 15.25 |
| 855081 | | |
| | TOTAL: | 100.00 |

TABLE 14
Ingredient list for a peanut-butter
cookie sweet goods dough wet blend.

| Ingredient | Source | Weight % |
|---|---|---|
| Shortening, | ADM | 48.25 |
| 106-100 low trans | | |
| Peanut butter, creamy | Algood, Dawn Food | 21.83 |
| | Ingredients | |
| Molasses, Robust | ChiSweet | 4.27 |
| Corn syrup, 62 DE | Corn Products | 12.61 |
| Corn syrup, 42% fructose | Corn Products | 12.61 |
| Color #111 | D D Williamson | 0.43 |
| | TOTAL: | 100.00 |

### 14. An Oatmeal Raisin Cookie Sweet Goods Dough Dry and Wet Blend Formulation

A dry and wet blend of an oatmeal raisin cookie dough is prepared using the following list of ingredients. Ingredient proportions are listed as percent by weight of the final weight of the dry and wet composition respectively.

TABLE 15
Ingredient list for an oatmeal raisin
cookie sweet goods dough dry blend.

| Ingredient | Source | Weight % |
|---|---|---|
| Extra fine granulated sucrose | ChiSweet - Cargill | 27.41 |
| Powdered whole egg | Sonstegard | 3.07 |
| Potassium sorbate | ChiSweet | 0.93 |
| Encapsulated soda, 50% | Watson Foods | 0.93 |
| Salt, flour | Cargill | 0.39 |
| Cinnamon, ground 2.0 60 mesh | Dawn Foods | 0.31 |
| Flour, hotel & restaurant | ConAgra | 21.24 |
| Oats, old-fashioned | Dawn Foods | 31.85 |
| Raisins, midget | Dawn Foods | 13.86 |
| | TOTAL: | 100.00 |

TABLE 16
Ingredient list for an oatmeal raisin
cookie sweet goods dough wet blend.

| Ingredient | Source | Weight % |
|---|---|---|
| Shortening, 106-100 low trans | ADM | 48.61 |
| Molasses, robust | ChiSweet | 8.78 |
| Corn syrup, 62 DE | ChiSweet | 21.13 |
| Corn syrup, 42% fructose | ChiSweet | 21.13 |
| Vanilla, FAGR883 | Wild Flavors | 0.34 |
| | TOTAL: | 100.00 |

### 15. A Sugar Cookie Sweet Goods Dough Dry and Wet Blend Formulation

A dry and wet blend of a sugar cookie dough is prepared using the following list of ingredients. Ingredient proportions are listed as percent by weight of the final weight of the dry and wet composition respectively.

TABLE 17
Ingredient list for a sugar cookie sweet goods dough dry blend.

| Ingredient | Source | Weight % |
|---|---|---|
| Extra Fine granulated sucrose | ChiSweet | 36.04 |
| Powdered whole egg | Primera | 3.62 |
| Potassium Sorbate | ChiSweet | 1.02 |
| Salt, flour | Cargill | 0.86 |
| Encapsulated soda, 50% | Watson Foods | 1.02 |
| Hotel & restaurant flour | ConAgra | 57.45 |
| | TOTAL: | 100.000 |

TABLE 18
Ingredient list for a sugar cookie sweet goods dough wet blend.

| Ingredient | Source | Weight % |
|---|---|---|
| Shortening, 106-100 low trans | ADM | 56.57 |
| Corn syrup, 62 DE | ChiSweet | 21.63 |
| Corn syrup, 42% fructose | ChiSweet | 21.63 |
| Butter/vanilla flavor, 072-00434 | Cargill | 0.17 |
| | TOTAL: | 100.000 |

### 16. A Brownie Sweet Goods Dough Dry and Wet Blend Formulation

A dry and wet blend of a brownie dough is prepared using the following list of ingredients. Ingredient proportions are listed as percent by weight of the final weight of the dry and wet composition respectively.

TABLE 19
Ingredient list for a brownie sweet goods dough dry blend.

| Ingredient | Source | Weight % |
|---|---|---|
| Extra fine granulated sucrose | United Sugars | 39.71 |
| Encapsulated soda, 50% | Watson | 1.59 |
| Flour salt | Cargill | 0.52 |
| Powdered whole egg | Primera | 7.91 |
| Cocoa, Russet Plus | Wilbur/ADM | 10.56 |
| Defender H&R flour | Cargill | 39.71 |
| Chocolate chips 1M, 67336 | Blommer | 43.57 |
| | TOTAL | 100.00 |

TABLE 20
Ingredient list for a brownie sweet goods dough wet blend.

| Ingredient | Source | Weight % |
|---|---|---|
| Low trans shortening, 106-100 | ADM | 65.22 |
| Corn syrup, 42% fructose | Chicago Sweeteners | 17.00 |
| Corn syrup, 62DE | Chicago Sweeteners | 17.00 |
| Vanilla, FAGR883 | Wild | 0.78 |
| | TOTAL | 100.00 |

A number of embodiments of the invention have been described. Nevertheless, it will be understood that various modifications may be made without departing from the spirit and scope of the invention. For example, while a chocolate chip cookie dough has been expressly presented above, other ingredients that provide variety in constituents may be added, for example, nuts, chewy or hard candies, caramels, fudge, and the like. Accordingly, other embodiments are within the scope of the following claims.

What is claimed is:

1. A shelf-stable, yeastless sweet goods dough composition, comprising:
a. from about 8 to about 25% by weight of fats and oils,
b. from about 0.5 to about 4% by weight powdered eggs,
c. from about 5 to about 25% by weight of sucrose,
d. from about 6 to about 60% by weight of a liquid sweetener,
e. from about 12 to about 40% by weight of flour,
f. from about 0 to about 10% by weight of neat water,
g. from about 0 to about 1.0% by weight antimicrobial agent,
h. from about 0.2 to about 1.2% by weight salt,
i. from about 0 to about 5% by weight molasses,
j. from about 0.5 to about 2.0% by weight leavening agent;
wherein all of said percentages are based on the total weight of the dough composition, the total water content of the dough composition being about 4.5% by weight, the pH of the dough being about 6.8 to about 7.2, and having a water activity in the range of about 0.65 to about 0.75, wherein said dough composition exhibits substantially no browning for a period of six weeks following preparation.

2. The shelf-stable, yeastless sweet goods dough composition of claim 1, wherein the fats and oils is a mixture substantially free of unsaturated trans-fatty acids.

3. The shelf-stable, yeastless sweet goods dough composition of claim 1, wherein the powdered eggs are powdered whole eggs.

4. The shelf-stable, yeastless sweet goods dough composition of claim 1, wherein the liquid sweetener comprises a blend of corn syrups.

5. The shelf-stable, yeastless sweet goods dough composition of claim 4, wherein the blend of corn syrups comprises a mixture of about 1:1 of about 62 DE corn syrup and about 42% fructose corn syrup.

6. The shelf-stable, yeastless sweet goods dough composition of claim 1, wherein the flour is an all-purpose flour substantially free of barley flour.

7. The shelf-stable, yeastless sweet goods dough composition of claim 1, wherein some or all of the flour is corn meal, corn flour, or mixtures thereof.

8. The shelf-stable, yeastless sweet goods dough composition of claim 1, wherein the antimicrobial agent is dry potassium sorbate.

9. The shelf-stable, yeastless sweet goods dough composition of claim 1, wherein the leavening agent is encapsulated soda.

10. The shelf-stable, yeastless sweet goods dough composition of claim 1, wherein the dough is a chocolate chip cookie dough comprising about 15 to about 25% by weight of chocolate chips.

11. The shelf-stable, yeastless sweet goods dough composition of claim 1, wherein the dough further comprises about 0.075 to about 1% by weight vanilla flavoring.

12. A shelf-stable, yeastless sweet goods dough composition, comprising:
a. from about 12 to about 23% by weight of fats and oils,
b. from about 1.5 to about 3% by weight powdered eggs,
c. from about 18 to about 23% by weight of sucrose,
d. from about 6 to about 20% by weight of a liquid sweetener,
e. from about 10 to about 35% by weight of flour,
f. from about 2 to about 8% by weight of water, wherein the water is added as neat water, a separate ingredient distinguished from moisture content present in other ingredients,
g. from about 0.4 to about 1.0% by weight antimicrobial agent,
h. from about 0.4 to about 1.0% by weight salt,
i. from about 0 to about 3% by weight molasses,
j. from about 0.5 to about 1.5% by weight leavening agent;
wherein all of said percentages are based on the total weight of the dough composition, the total water content of the dough composition being about 4.5% by weight, the pH of the dough being about 6.8 to about 7.2, and having a water activity in the range of about 0.65 to about 0.75, wherein said dough composition exhibits little or substantially no browning for a period of six weeks following preparation.

13. The shelf-stable, yeastless sweet goods dough composition of claim 12, wherein the fats and oils is a mixture substantially free of unsaturated trans-fatty acids.

14. The shelf-stable, yeastless sweet goods dough composition of claim 12, wherein the powdered eggs are powdered whole eggs.

15. The shelf-stable, yeastless sweet goods dough composition of claim 12, wherein the liquid sweetener comprises a blend of corn syrups.

16. The shelf-stable, yeastless sweet goods dough composition of claim 15, wherein the blend of corn syrups comprises a mixture of about 1:1 of about 62 DE corn syrup and about 42% fructose corn syrup.

17. The shelf-stable, yeastless sweet goods dough composition of claim 12, wherein the flour is an all-purpose flour substantially free of barley flour.

18. The shelf-stable, yeastless sweet goods dough composition of claim 12, wherein some or all of the flour is corn meal, corn flour, or mixtures thereof.

19. The shelf-stable, yeastless sweet goods dough composition of claim 12, wherein the antimicrobial agent is dry potassium sorbate.

20. The shelf-stable, yeastless sweet goods dough composition of claim 12, wherein the leavening agent is encapsulated soda.

21. The shelf-stable, yeastless sweet goods dough composition of claim 12, wherein the dough is a chocolate chip cookie dough comprising about 15 to about 25% by weight of chocolate chips.

22. The shelf-stable, yeastless sweet goods dough composition of claim 12, wherein the dough further comprises about 0.05 to about 0.5% by weight vanilla flavoring.

23. A shelf-stable, yeastless sweet goods dough composition, comprising:
a. 13.75% by weight of fats and oils,
b. 2% by weight powdered eggs,
c. 20.62% by weight of sucrose,
d. 12% by weight of a liquid sweetener,
e. 27.49% by weight of flour,
f. 4.5% by weight of neat water,
g. 0.59% by weight antimicrobial agent,
h. 0.6% by weight salt,
i. 0.2% by weight molasses,
j. 0.2% by weight vanilla flavoring,
k. 0.25% by weight butter flavoring,
l. 1.32% by weight leavening agent,
m. 16.49% by weight flavor additives;
wherein all of said percentages are based on the total weight of the dough composition, the total water content of the dough composition being about 4.5% by weight, the pH of the dough being about 6.8 to about 7.2, and having a water activity in the range of about 0.65 to about 0.75, wherein said dough composition exhibits little or substantially no browning for a period of six weeks following preparation.

24. A shelf-stable, yeastless sweet goods dough composition, comprising:
a. 14.13% by weight of fats and oils,
b. 2.01% by weight powdered eggs,
c. 20.19% by weight of sucrose,
d. 12.04% by weight of a liquid sweetener,
e. 28.27% by weight of flour,
f. 3.51% by weight of neat water,
g. 0.60% by weight antimicrobial agent,
h. 0.85% by weight salt,
i. 0.2% by weight molasses,
j. 0.17% by weight vanilla flavoring,
k. 0.50% by weight butter/vanilla flavoring,
l. 1.32% by weight leavening agent,
m. 16.56% by weight flavor additives;
wherein all of said percentages are based on the total weight of the dough composition, the total water content of the dough composition being about 4.5% by weight, the pH of the dough being about 6.8 to about 7.2, and having a water activity in the range of about 0.65 to about 0.75, wherein said dough composition exhibits little or substantially no browning for a period of six weeks following preparation.

25. The shelf-stable, yeastless sweet goods dough composition of claim 23 or 24, wherein the fats and oils is a mixture substantially free of unsaturated trans-fatty acids.

26. The shelf-stable, yeastless sweet goods dough composition of claim 23 or 24, wherein the powdered eggs are powdered whole eggs.

27. The shelf-stable, yeastless sweet goods dough composition of claim 23 or 24, wherein the flour is an all-purpose flour substantially free of barley flour.

28. The shelf-stable, yeastless sweet goods dough composition of claim 23 or 24, wherein the liquid sweetener comprises a binary mixture of sweetener liquids.

29. The shelf-stable, yeastless sweet goods dough composition of claim 28, wherein the binary mixture of sweetener liquids comprises a 1:1 ratio of corn syrups.

30. The shelf-stable, yeastless sweet goods dough composition of claim 28, where the binary mixture of sweetener liquids comprises equal weights of 62 DE corn syrup and 42% fructose corn syrup.

31. The shelf-stable, yeastless sweet goods dough composition of claim 23 or 24, wherein the flavor additives comprise chocolate chips.

32. A shelf-stable, yeastless sweet goods dough composition, comprising:
a. 16.93% by weight of fats and oils,
b. 1.64% by weight powdered eggs,
c. 19.59% by weight of sucrose,
d. 8.85% by weight of a liquid sweetener,
e. 24.40% by weight of flour,
f. 5.92% by weight of neat water,
g. 0.55% by weight antimicrobial agent,
h. 0.55% by weight salt,
i. 1.50% by weight molasses,
j. 0.73% by weight leavening agent,
k. 7.66% by weight peanut butter;
l. 2.55% by weight peanut flour;
m. 9.0% by weight flavor additives;
wherein all of said percentages are based on the total weight of the dough composition, the total water content of the dough composition being about 4.5% by weight, the pH of the dough being about 6.8 to about 7.2, and having a water activity in the range of about 0.65 to about 0.75, wherein said dough composition exhibits little or substantially no browning for a period of six weeks following preparation.

33. The shelf-stable, yeastless sweet goods dough composition of claim 32, wherein the fats and oils is a mixture substantially free of unsaturated trans-fatty acids.

34. The shelf-stable, yeastless sweet goods dough composition of claim 32, wherein the powdered eggs are powdered whole eggs.

35. The shelf-stable, yeastless sweet goods dough composition of claim 32, wherein the flour is an all-purpose flour substantially free of barley flour.

36. The shelf-stable, yeastless sweet goods dough composition of claim 32, wherein the liquid sweetener is comprised of a binary mixture of sweetener liquids.

37. The shelf-stable, yeastless sweet goods dough composition of claim 36, wherein the binary mixture of sweetener liquids comprises a 1:1 ratio of corn syrups.

38. The shelf-stable, yeastless sweet goods dough composition of claim 36, wherein the binary mixture of sweetener liquids comprises equal weights of 62 DE corn syrup and 42% fructose corn syrup.

39. The shelf-stable, yeastless sweet goods dough composition of claim 32, wherein the flavor additives comprise peanut flavored chips.

40. A shelf-stable, yeastless sweet goods dough composition, comprising:
a. 14.17% by weight of fats and oils,
b. 2.05% by weight powdered eggs,
c. 18.29% by weight of sucrose,
d. 12.32% by weight of a liquid sweetener,
e. 14.17% by weight of flour,
f. 4.11% by weight of neat water,
g. 0.62% by weight antimicrobial agent,
h. 0.26% by weight salt,
i. 2.56% by weight molasses,
j. 0.1% by weight vanilla flavoring,
k. 0.62% by weight leavening agent,
l. 0.21% by weight cinnamon;
m. 21.25% by weight oats;
n. 9.25% by weight raisins;
wherein all of said percentages are based on the total weight of the dough composition, the total water content of the dough composition being about 4.5% by weight, the pH of the dough being about 6.8 to about 7.2, and having a water activity in the range of about 0.65 to about 0.75, wherein said dough composition exhibits little or substantially no browning for a period of six weeks following preparation.

41. The shelf-stable, yeastless sweet goods dough composition of claim 40, wherein the fats and oils is a mixture substantially free of unsaturated trans-fatty acids.

42. The shelf-stable, yeastless sweet goods dough composition of claim 40, wherein the powdered eggs are powdered whole eggs.

43. The shelf-stable, yeastless sweet goods dough composition of claim 40, wherein the flour is an all-purpose flour substantially free of barley flour.

44. The shelf-stable, yeastless sweet goods dough composition of claim 40, wherein the liquid sweetener comprises a binary mixture of sweetener liquids.

45. The shelf-stable, yeastless sweet goods dough composition of claim 44, wherein the binary mixture of sweetener liquids comprises a 1:1 ratio of corn syrups.

46. The shelf-stable, yeastless sweet goods dough composition of claim 44, where the binary mixture of sweetener liquids comprises equal weights of 62 DE corn syrup and 42% fructose corn syrup.

47. A shelf-stable, yeastless sweet goods dough composition, comprising:
a. 20.92% by weight of fats and oils,
b. 2.10% by weight powdered eggs,
c. 20.91% by weight of sucrose,
d. 16.0% by weight of a liquid sweetener,
e. 33.33% by weight of flour,
f. 5.0% by weight of neat water,
g. 0.59% by weight antimicrobial agent,
h. 0.5% by weight salt,
i. 0.063% by weight butter/vanilla flavoring,
j. 0.59% by weight leavening agent,
wherein all of said percentages are based on the total weight of the dough composition, the total water content of the dough composition being about 4.5% by weight, the pH of the dough being about 6.8 to about 7.2, and having a water activity in the range of about 0.65 to about 0.75, wherein said dough composition exhibits little or substantially no browning for a period of six weeks following preparation.

48. The shelf-stable, yeastless sweet goods dough composition of claim 47, wherein the fats and oils is a mixture substantially free of unsaturated trans-fatty acids.

49. The shelf-stable, yeastless sweet goods dough composition of claim 47, wherein the powdered eggs are powdered whole eggs.

50. The shelf-stable, yeastless sweet goods dough composition of claim 47, wherein the flour is an all-purpose flour substantially free of barley flour.

51. The shelf-stable, yeastless sweet goods dough composition of claim 47, wherein the liquid sweetener comprises a binary mixture of sweetener liquids.

52. The shelf-stable, yeastless sweet goods dough composition of claim 49, wherein the binary mixture of sweetener liquids comprises a 1:1 ratio of corn syrups.

53. The shelf-stable, yeastless sweet goods dough composition of claim 50, where the binary mixture of sweetener liquids comprises equal weights of 62 DE corn syrup and 42% fructose corn syrup.

54. The shelf-stable, yeastless sweet goods dough composition of claim 47, wherein the antimicrobial agent is potassium sorbate.

55. The shelf-stable, yeastless sweet goods dough composition of claim 47, wherein the leavening agent is encapsulated soda.

56. A process for making shelf-stable, yeastless sweet goods dough composition, comprising:
a. mixing together desired amounts of fats and oils, powdered eggs, sucrose, liquid sweetener, water, antimicrobial agent, salt, molasses, vanilla, butter flavor, and leavening agent to form a substantially homogeneous mixture;
b. blending said substantially homogeneous mixture with flour to form a dough composition; and
c. pumping said dough composition of step (b) to a packaging device;
wherein the total water content of the dough composition is about 4.5% by weight, the pH of the dough being about 6.8 to about 7.2, and having a water activity in the range of about 0.65 to about 0.75, and wherein said dough composition exhibits little or substantially no browning for a period of six weeks following preparation.

57. The process of claim 56, wherein the fats and oils is a mixture substantially free of unsaturated trans-fatty acids.

58. The process of claim 56, wherein the powdered eggs are powdered whole eggs.

59. The process of claim 56, wherein the liquid sweetener comprises a binary mixture of sweetener liquids.

60. The process of claim 59, wherein the binary mixture comprises a mixture of about 1:1 of about 62 DE corn syrup and about 42% fructose corn syrup.

61. The process of claim 56, wherein the flour is an all-purpose flour substantially free of barley flour.

62. The process of claim 56, wherein the antimicrobial agent is dry potassium sorbate.

63. The process of claim 56, wherein the dough is a chocolate chip cookie dough.

64. A shelf-stable, yeastless sweet goods dough composition, comprising:
a. 20.10% by weight of fats and oils,
b. 3.49% by weight powdered eggs,
c. 17.53% by weight of sucrose,
d. 10.48% by weight of a liquid sweetener,
e. 17.53% by weight of flour,
f. 5.82% by weight of neat water,
g. 0.23% by weight salt,
h. 0.24% by weight vanilla flavoring,
i. 0.70% by weight leavening agent,
j. 4.66% by weight cocoa,
k. 19.23% by weight chocolate chips,
wherein all of said percentages are based on the total weight of the dough composition, the total water content of the dough composition being about 4.5% by weight, the pH of the dough being about 6.8 to about 7.2, and having a water activity in the range of about 0.65 to about 0.75, wherein said dough composition exhibits little or substantially no browning for a period of six weeks following preparation.

65. The shelf-stable, yeastless sweet goods dough composition of claim 64, wherein the fats and oils is a mixture substantially free of unsaturated trans-fatty acids.

66. The shelf-stable, yeastless sweet goods dough composition of claim 64, wherein the powdered eggs are powdered whole eggs.

67. The shelf-stable, yeastless sweet goods dough composition of claim 64, wherein the flour is an all-purpose flour substantially free of barley flour.

68. The shelf-stable, yeastless sweet goods dough composition of claim 64, wherein the liquid sweetener comprises a binary mixture of sweetener liquids.

69. The shelf-stable, yeastless sweet goods dough composition of claim 68, wherein the binary mixture of sweetener liquids comprises a 1:1 ratio of corn syrups.

70. The shelf-stable, yeastless sweet goods dough composition of claim 69, where the binary mixture of sweetener liquids comprises equal weights of 62 DE corn syrup and 42% fructose corn syrup.

71. The shelf-stable, yeastless sweet goods dough composition of claim 64, wherein the leavening agent is encapsulated soda.

72. A yeastless sweet goods dough dry blend composition, comprising:
a. from about 2.5 to about 5% by weight powdered eggs,
b. from about 28 to about 34.5% by weight of sucrose,
c. from about 54.5 to about 68% by weight of flour,
d. from about 0 to about 1.4% by weight antimicrobial agent,
e. from about 1.0 to about 1.6% by weight salt, and
f. from about 0 to about 2.7% by weight leavening agent;
wherein all of said percentages are based on the total weight of the dry blend composition.

73. A yeastless sweet goods dough dry blend composition, comprising:
a. from about 4.5 to about 5% by weight powdered eggs,
b. from about 35.5 to about 58.5% by weight of sucrose,
c. from about 32.6 to about 54.5% by weight of flour,
d. from about 1.3 to about 1.6% by weight antimicrobial agent,
e. from about 1.3 to about 1.6% by weight salt, and
f. from about 1.6 to about 2.3% by weight leavening agent;
wherein all of said percentages are based on the total weight of the dry blend composition.

74. A yeastless sweet goods dough wet blend composition, comprising:
a. from about 27.5 to about 57.5% by weight of fats and oils,
b. from about 42.5 to about 67% by weight of a liquid sweetener, and
c. from about 0 to about 6% by weight molasses;
wherein all of said percentages are based on the total weight of the wet blend composition.

75. A yeastless sweet goods dough wet blend composition, comprising:
a. from about 50 to about 67% by weight of fats and oils,
b. from about 33 to about 43.5% by weight of a liquid sweetener, and
c. from about 0 to about 6.5% by weight molasses;
wherein all of said percentages are based on the total weight of the wet blend composition.

76. A yeastless sweet goods dough dry blend composition, comprising:
a. 2.89% by weight powdered eggs,
b. 29.84% by weight sucrose,
c. 39.78% by weight flour,
d. 0.85% by weight antimicrobial agent,
e. 0.87% by weight salt,
f. 1.91% by weight leavening agent, and
g. 23.86% by weight flavor additives;
wherein all of said percentages are based on the total weight of the dry blend composition.

77. A yeastless sweet goods dough wet blend composition, comprising:
a. 52.10% by weight of fats and oils,
b. 45.43% by weight of a liquid sweetener,
c. 0.76% by weight molasses,
d. 0.76% by weight vanilla flavoring, and
e. 0.95% by weight butter flavoring;
wherein all of said percentages are based on the total weight of the wet blend composition.

78. A yeastless sweet goods dough dry blend composition, comprising:
a. 2.88% by weight powdered eggs,
b. 28.92% by weight sucrose,
c. 40.50% by weight flour,
d. 0.86% by weight antimicrobial agent,
e. 1.22% by weight salt,
f. 1.89% by weight leavening agent, and
g. 23.72% by weight flavor additives;
wherein all of said percentages are based on the total weight of the dry blend composition.

79. A yeastless sweet goods dough wet blend composition, comprising:
a. 52.96% by weight of fats and oils,
b. 45.12% by weight of a liquid sweetener,
c. 0.75% by weight molasses,
d. 0.64% by weight butter/vanilla flavoring, and
e. 0.34% by weight sweet brown butter;
wherein all of said percentages are based on the total weight of the wet blend composition.

80. A yeastless sweet goods dough dry blend composition, comprising:
a. 2.78% by weight powdered eggs,
b. 33.20% by weight sucrose,
c. 41.35% by weight flour,
d. 0.93% by weight antimicrobial agent,
e. 0.93% by weight salt,
f. 1.24% by weight leavening agent,
g. 4.32% by weight peanut flour, and
h. 15.25% by weight flavor additives;
wherein all of said percentages are based on the total weight of the dry blend composition.

81. A yeastless sweet goods dough wet blend composition, comprising:
a. 48.25% by weight of fats and oils,
b. 25.22% by weight of a liquid sweetener,
c. 4.27% by weight molasses, and
d. 21.83% by weight peanut butter;
wherein all of said percentages are based on the total weight of the wet blend composition.

82. A yeastless sweet goods dough dry blend composition, comprising:
a. 3.07% by weight powdered eggs,
b. 27.41% by weight sucrose,
c. 21.24% by weight flour,
d. 0.93% by weight antimicrobial agent,
e. 0.39% by weight salt,
f. 0.93% by weight leavening agent,
g. 0.31% by weight cinnamon,
h. 31.85% by weight oats, and
i. 13.86% by weight raisins;
wherein all of said percentages are based on the total weight of the dry blend composition.

83. A yeastless sweet goods dough wet blend composition, comprising:
a. 48.61% by weight of fats and oils,
b. 42.26% by weight of a liquid sweetener,
c. 8.78% by weight molasses, and
d. 0.34% by weight vanilla flavoring;
wherein all of said percentages are based on the total weight of the wet blend composition.

84. A yeastless sweet goods dough dry blend composition, comprising:
a. 3.62% by weight powdered eggs,
b. 36.04% by weight sucrose,
c. 57.45% by weight flour,
d. 1.02% by weight antimicrobial agent,
e. 0.86% by weight salt, and
f. 1.02% by weight leavening agent;
wherein all of said percentages are based on the total weight of the dry blend composition.

85. A yeastless sweet goods dough wet blend composition, comprising:
a. 56.57% by weight of fats and oils,
b. 43.23% by weight of a liquid sweetener, and
c. 0.17% by weight butter/vanilla flavoring;
wherein all of said percentages are weights on the total weight of the wet blend composition.

86. A yeastless sweet goods dough dry blend composition, comprising:
a. 7.91% by weight powdered eggs,
b. 39.71% by weight sucrose,
c. 39.71% by weight flour,
d. 0.52% by weight salt,
e. 1.59% by weight leavening agent,
f. 10.56% by weight cocoa, and
g. 43.57% by weight chocolate chips;
wherein all of said percentages are based on the total weight of the dry blend composition.

87. A yeastless sweet goods dough wet blend composition, comprising:
a. 65.22% by weight of fats and oils,
b. 34% by weight of a liquid sweetener,
c. 0.78% by weight vanilla flavoring,
wherein all of said percentages are based on the total weight of the wet blend composition.
